(19) United States
(12) Patent Application Publication
(10) Pub. No.: US 2012/0183399 A1
(43) Pub. Date: Jul. 19, 2012

(54) METHOD AND APPARATUS FOR BALANCING WIND TURBINES

(75) Inventor: Robert H. Perkinson, Somers, CT (US)

(73) Assignee: HAMILTON SUNDSTRAND CORPORATION, Windsor Locks, CT (US)

(21) Appl. No.: 13/009,402

(22) Filed: Jan. 19, 2011

(51) Int. Cl. B64C 27/57

(52) U.S. Cl. 416/1; 416/145

(57) ABSTRACT

A method for balancing blades of a wind turbine comprises several steps. First, vibration sensor readings are taken while wind turbine blades are in a pre-balancing configuration. These vibration sensor readings are used to determine initial blade imbalance. Next, vibration sensor readings are taken while wind turbine blades are in a first and a second pitch offset configuration. These vibration sensor readings are used to determine system response to the first and second pitch offset configurations. A correction pitch configuration is determined from the initial blade imbalance and the system response. Finally, blades of the wind turbine are pitched according to the correction pitch configuration.

### BACKGROUND

The present invention relates generally to wind turbines, and more particularly to in-situ balancing of wind turbine blades.

Wind turbine blades must be balanced to minimize undesired vibration and any destructive structural loading that may result. Blade imbalance can cause tower-wide vibrations and expose turbine components to harmful stresses which can dramatically reduce component lifetimes. Furthermore, blade imbalance may reduce the efficiency of energy generation as the result of increased operating costs due to premature parts replacement. Net blade imbalance is the result of mass imbalance and aerodynamic imbalance. Mass imbalance describes the misalignment of the rotational moment of a collection of blades, and is a function only of the mass distribution of the blade set. Aerodynamic imbalance describes the effect of blade position in an air stream on the effective moment of a collection of blades. In particular, aerodynamic imbalance can arise where blade pitching is not identical across all blades.

Conventional methods for balancing wind turbine blades are usually adequate to minimize mass imbalance. Individual blades are typically balanced against test masses to check that mass imbalances are within specified tolerances during manufacture. Although slight mass imbalances may appear in an assembled wind turbine, these imbalances are ordinarily negligible. Aerodynamic blade imbalance, however, cannot be checked at this stage, and may be very significant, particularly at high wind speeds. Aerodynamic imbalance may be the result of variations in the aerodynamic profile as a result of tolerances in the blade manufacturing process, or the result of angle of attack variations of the assembled blade set caused by tolerances in the pitch setting mechanisms.

Conventional methods for dealing with aerodynamic blade imbalance are limited. Blades are ordinarily pitched as close to identically as possible, and the pitch of individual blades is seldom controlled separately. Rebalancing is usually expensive, requires specialized equipment, and often necessitates that a wind turbine be taken offline for extended periods during the balancing process. Rebalancing an assembled turbine is typically a prolonged process during which the turbine must be stopped, and blades may need to be removed and relocated to a separate facility.

### SUMMARY

The present invention is directed toward a method and associated apparatus for balancing wind turbine blades. Vibration sensor readings are taken at multiple blade pitch configurations, and used to determine a correction blade pitch configuration which minimizes net blade imbalance. Turbine blades are then pitched according to this correction blade pitch configuration, thereby reducing blade system imbalance.

### BRIEF DESCRIPTION OF THE DRAWINGS

FIG. 1 is a simplified view of a wind turbine and tower.

FIG. 2 is a block diagram the wind turbine of the present invention.

FIG. 3 is a flow chart describing the steps of the balancing method of the present invention.

### DETAILED DESCRIPTION

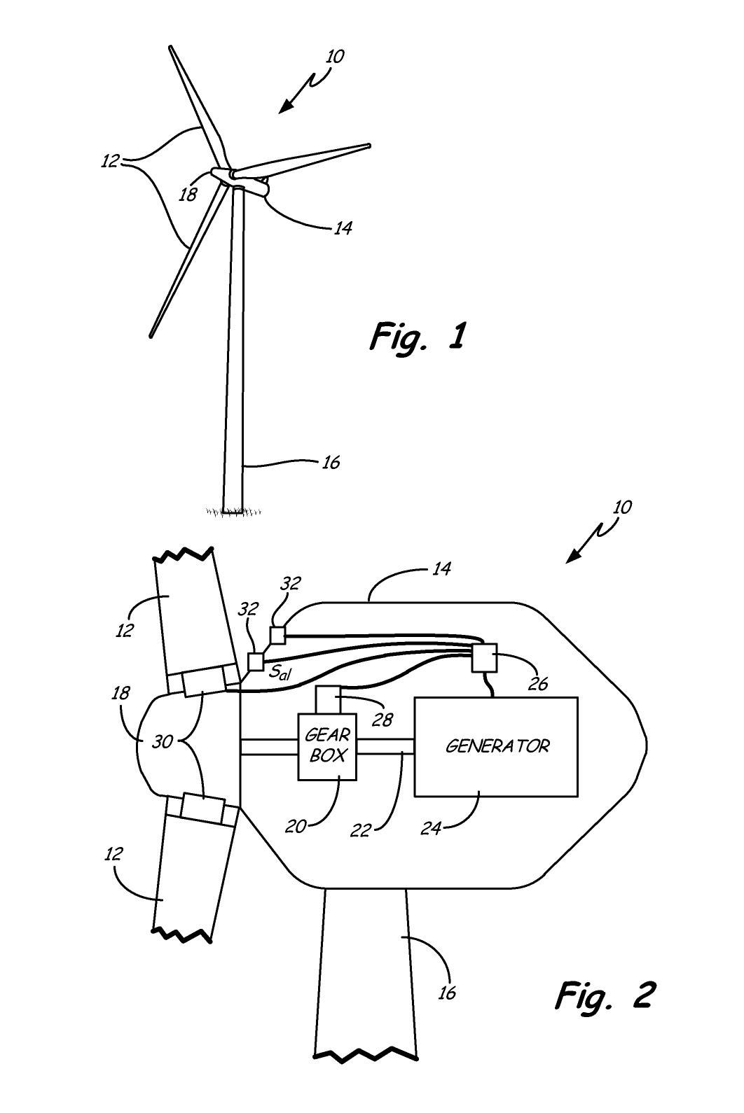

FIG. 1 shows wind turbine system 10, with blades 12, nacelle 14, tower 16, and hub 18. Tower 16 supports nacelle 14, and blades 12 meet nacelle 14 at hub 18. The assembly of the blades and hub is commonly referred to as the rotor. Airflow incident on a plane defined by blades 12 will move blades 12, rotating hub 18. Although FIG. 1 shows wind turbine system 10 with only three blades 12, it will be understood by one skilled in the art that other numbers of blades can be used.

FIG. 2 is a block diagram of wind turbine system 10, including blades 12, nacelle 14, tower 16, hub 18, gearbox 20, drive shaft 22, generator 24, controller 26, vibration sensor 28, and pitch actuators 30, wind speed sensor 32, blade revolution sensor 34 (which transmits alignment signal Sₐₗ. When wind moves blades 12, the rotation of hub 18 is translated through gearbox 20 by drive shaft 22. Gearbox 20 converts the low speed rotation of hub 18 into high speed rotation used by generator 24 to produce electric power. Controller 26 is a logic device capable of executing the balancing algorithm described hereinafter, and connected to vibration sensor 28 and pitch actuators 30. Although controller 26 is shown within nacelle 14, it may be located elsewhere. Wind speed sensor 32 provides a wind speed reading to controller 26. This wind speed reading is used in the present balancing method, as well as for conventional purposes common in the control of wind turbines. Controller 26 regulates the pitch of blades 12; where convenient, controller 26 may also control other parameters such as nacelle yaw and generator function; as shown in FIG. 2, controller 26 is additionally connected, by way of example, to generator 24.

In the depicted system, a single vibration sensor 28 is located on gearbox 20. Multiple vibration sensors 28 can be used, however, and vibration sensor 28 can be located anywhere where translation from tower motion as a result of rotor vibration is relatively large. Vibration sensor 28 is typically an acceleration transducer which measures vibration amplitudes across a range of frequencies. Other transducers may be used which determine the motion amplitude of the tower and nacelle system. Vibration sensors connected to controller 26 are commonly used in the art to detect dangerous vibration conditions in tower 16, gearbox 20, and other components. In one embodiment of the present invention, vibration sensor 28 is such an existing vibration sensor. In another embodiment, vibration sensor 28 is a separate transducer specific to the balancing system of the present invention. In either case, vibration sensor 28 is sensitive to vibrations of a direction and frequency range corresponding likely to be caused by rotor imbalance. If vibration sensor 28 is also used to detect vibration for other purposes, as discussed above, vibration sensor 28 may be sensitive to a broader frequency range.

Blade revolution sensor 34 provides a signal indicating angular position of blades 12. In one embodiment, blade revolution sensor 34 is a magnetic sensor which aligns once per complete revolution with a magnetic indicator at a fixed location of the rotating assembly comprising blades 12 and hub 18. Revolution sensor 34 transmits digital alignment signal Sₐₗ to controller 26 once per complete revolution of blades 12 and hub 18, indicating that the fixed location is aligned with magnetic sensor 34. The frequency of alignment signals Sₐₗ is the inverse of the average angular velocity of blades 12 and hub 18. So long as the angular velocity of blades 12 and hub 18 is relatively constant over a single revolution, the time lapse since transmission of alignment signal Sₐₗ corresponds to an angular position of blades 12 and hub 18 (rotor angular position). In other embodiments, blade revolution sensor 34 could comprise alternative sensor means capable of providing rotor speed and angular position.

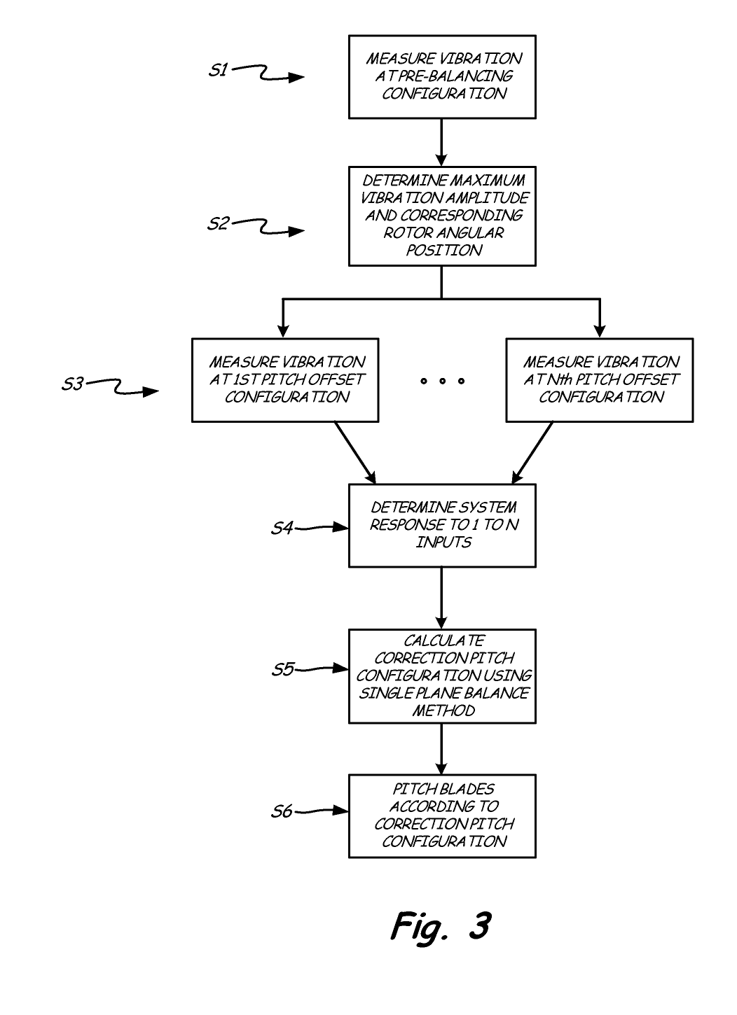

FIG. 3 is a flow chart describing the balancing method of the present invention. Initial vibration readings are first taken from vibration sensor 28 while all blades are in a “pre-balancing” condition, and are pitched nominally identically (Step S1). This “pre-balancing” condition may be an as-assembled condition of blades 12 and hub 18, with blade pitch calibrated per existing practice. Alternatively, the “pre-balancing” condition may be the result of prior balancing adjustments according to the present invention. Alignment signals Sₐₗ indicate rotor angular position, as described above. The vibrational magnitude and the rotor angular position corresponding to maximum vibration amplitude together describe net rotor imbalance, and are noted by controller 26 (Step S2).

Next, one or more blades 12 are pitched at known angles in each of N distinct pitch offset configurations. Vibration readings from vibration sensor 28 are taken at first through Nth pitch configurations (Step S3), and are used by controller 26 to determine the sensitivity of the system to blade pitch changes 1 through N (Step S4). As in Step S2, controller 26 notes the maximum vibrational magnitude and corresponding rotor angular position at each pitch offset configuration. Controller 26 then determines a correction pitch configuration based on the results of Step S4, using a single plane balance method, as is well known in the art. (Step S5), and pitch actuators 30 adjust the pitch of blades 12 correspondingly (Step S6). The corrected configuration is incorporated as a fixed offset in the normal control algorithms embodied in controller 26.

There may be multiple pitch correction solutions which minimize net blade imbalance, depending on the number of blades and the number of test cases conducted in Step 3. The optimal solution is the solution which requires the minimum correction in pitch to the least number of blades. It will be understood by those skilled in the art, however, that other solutions may also effectively reduce the unbalance.

All N pitch configurations must be distinct. In one embodiment, each pitch configuration is produced by pitching a single blade at a known angle while holding all other blades at their previous operating pitch. In this embodiment, the pitch of a first blade is varied in the first pitch configuration, the pitch of the second blade in the second configuration, and so on. At least two vibration readings are taken, and more readings may be taken to improve the accuracy of the balancing process. Because aerodynamic imbalance is a function of wind speed, wind speed sensor 32 provides measurements to controller 26 throughout steps S1 and S3.

Controller 26 determines the sensitivity of the system to the known imbalance introduced by the offset of each blade as previously described (Step S4). Controller 26 then determines a correction pitch configuration designed to minimize net blade imbalance (Step S5). In a correction pitch configuration, one or more blade pitches are changed to create a countervailing aerodynamic imbalance opposite to the measured net blade imbalance. In this way, net aerodynamic blade imbalance is cancelled. Blade pitches need not be identical—and seldom will be—in a correction pitch configuration. Controller 26 may determine correction pitch configurations computationally, or using a lookup table.

The present invention works well to correct moderate aerodynamic imbalances, but should not be used where blade imbalances are large. Large blade imbalances can indicate harmful defects which could be masked by the balancing method of the present invention. Accordingly, controller 26 will return a null correction pitch configuration in Step S5 (corresponding to no change in pitch) when the net blade imbalance determined in Step S2 falls outside of a predetermined “safe” range.

In Step S6, blades 12 are pitched according to the calculated correction configuration determined in Step S5. Controller 26 provides pitch control signals to pitch actuators 30 to orient blades 12 in the correction pitch configuration.

Although mass imbalance is independent of wind speed, aerodynamic imbalance becomes more pronounced at higher wind speeds. As a result, the induced countervailing aerodynamic imbalance at a fixed pitch will not be able to counteract net blade imbalance at all wind speeds, if the mass imbalance component of measured net blade imbalance is large. For large mass imbalances, a fixed correction pitch configuration that corrects for imbalance at low wind speeds will at best be less useful at high wind speeds, and vice versa. Fortunately, mass imbalance is ordinarily negligible in turbine systems assembled according to existing methods, and it may be assumed that, at operational wind speeds, the primary source of blade imbalance is aerodynamic imbalance. A fixed correction pitch configuration will ordinarily suffice to bring final blade imbalance within tolerances. Consequently, blade pitch for balancing need only be intermittently (not continuously) adjusted according to the balancing method of the present invention. This balancing method can be used periodically, or occasionally. For example, the balancing method of the present invention can constitute a special balancing mode entered into by controller 26 every few hours or weeks, or upon external trigger either by a human operator or by an automatic detector. Such a detector might, for instance, trigger entry into the balancing mode if readings from vibration sensor 28 exceeded acceptable values for a prolonged period. During the balancing mode, wind speed and vibration readings are gathered, and a new correction pitch configuration is determined.

Another embodiment of the present invention performs the aforementioned method continuously. Continuous pitch adjustment enables the method disclosed herein to counteract mass imbalance to a greater degree than possible with the only intermittent adjustment. Consequently, continuous pitch adjustment allows additional balancing where blades are insufficiently mass balanced during the manufacturing process. In this embodiment, the correction pitch is either continuously recalculated so as to update the correction pitch configuration in real time, or is calculated (either intermittently or continuously) as a function of wind speed, with controller 26 continually controlling pitch actuators 30 based on the output of wind speed sensor 32.

The present invention provides a fast and inexpensive method for balancing wind turbine blades in situ, thereby extending component lifetimes and enabling efficient power generation without the use of specialized equipment and without taking the wind turbine offline. This method requires specialized pitch control algorithms, as discussed above, but for the most part uses existing mechanical parts; many turbines could be adapted to use this method with existing pitch control actuators and vibration sensors.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for balancing blades of a wind turbine, comprising:
sensing vibration at a pre-balancing configuration;
noting pre-balancing rotor imbalance based on the sensed vibration at the pre-balancing configuration;
sensing vibration while the blades are in a first pitch offset configuration;
sensing a vibration while the blades are in a second pitch offset configuration distinct from the first pitch offset configuration;
determining system response to the first and second pitch offset configurations based on measured vibration;
producing a correction pitch configuration based pre-balancing rotor imbalance and system response to the first and second pitch offset configurations, the correction pitch configuration specifying the pitch of each blade so as to minimize rotor imbalance; and
controlling pitch of blades of the wind turbine according to the correction pitch configuration.

2. The method of claim 1, wherein the correction pitch offset configuration is produced using the single plane balance method, as is well known in the art.

3. The method of claim 1, wherein the correction pitch configuration does not call for a change in blade pitch if the unadjusted blade imbalance falls outside of a predetermined range.

4. The method of claim 1, further comprising:
entering into a balancing mode wherein normal operation of the wind turbine is suspended, prior to sensing vibrations in the first and second pitch offset configurations; and
exiting the balancing mode and returning to wind turbine normal operation after pitching blades according to the correction pitch configuration.

5. The method of claim 4, wherein entry into the balancing mode is triggered manually by an operator.

6. The method of claim 4, wherein entry into the balancing mode occurs automatically in response to sensed vibration amplitudes.

7. The method of claim 4, wherein entry into the balancing mode occurs periodically.

8. The method of claim 1, wherein the method is run continuously as a part of the ordinary operation of the wind turbine.

9. The method of claim 1, wherein:
in the first pitch offset configuration, a first blade is pitched to a known, fixed value, and no other blade pitches are altered from the pre-balancing configuration; and
in the second pitch offset configuration, a second blade is pitched at a known, fixed value, and no other blade pitches are altered from the pre-balancing configuration.

10. A wind turbine comprising:
a plurality of blades connected at a rotor;
a plurality of pitch control actuators capable of varying the pitch of each blade individually;
a generator connected to the rotor;
a vibration sensor sensitive to vibrations in a frequency range corresponding to blade imbalance;
a wind speed sensor;
a blade revolution sensor; and
a controller connected to the pitch control actuators, the vibration sensor, the wind speed sensor, and the blade revolution sensor to control blade pitch based on readings from the vibration sensor and the wind speed sensor.

11. The wind turbine of claim 10, wherein the controller balances the plurality of blades by:
determining pre-balancing blade imbalance based on signals from the vibration sensor, the wind speed sensor, and the blade revolution sensor;
determining system response to at least two distinct pitch offset configurations, based on signals from the vibration sensor, the wind speed sensor, and the blade revolution sensor;
producing a correction pitch configuration which specifies the pitch of each blade so as to minimizes blade imbalance based on the pre-balancing blade imbalance and the system response to the at least two distinct pitch offset configurations; and
commanding the pitch control actuators according to the correction pitch configuration.

12. The wind turbine of claim 11, wherein the correction pitch configuration minimizes blade imbalance by producing a countervailing aerodynamic imbalance.

13. The wind turbine of claim 10, wherein the vibration sensor is located on a gearbox between the rotor and the generator.

14. The wind turbine of claim 11, wherein each pitch offset configuration changes the pitch of one blade while leaving pitch of all other blades constant, and each pitch offset configuration changes the pitch of a different blade.
